(19) United States
(12) Patent Application Publication
(10) Pub. No.: US 2012/0318820 A1
(43) Pub. Date: Dec. 20, 2012

(54) Multiple Liquid Dispenser

(75) Inventors: Allan Amsel, Edison, NJ (US); Eliyahu Horowitz, Fresh Meadows, NY (US)

(73) Assignee: SAKAR INTERNATIONAL, INC, Edison, NJ (US)

(21) Appl. No.: 13/163,899

(22) Filed: Jun. 20, 2011

(51) Int. Cl. B67D 7/06; B67D 7/80

(52) U.S. Cl. 222/63; 222/146.1; 222/144.5; 222/52

(57) ABSTRACT

A Multiple Liquid Dispenser of the invention holds at least one or a plurality of liquids that are dispensed from a single appliance. The dispenser may contain liquids including beverages, sanitizers, hand soap and dish washing soap. The dispenser also has an elongated spout, a stable wide base and the option for a liquid temperature controller. Using a single appliance minimizes the amount of separated liquids containers that might be otherwise placed near the sink of the bathroom or kitchen.

### CROSS-REFERENCE TO REALTED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

A kitchen, bathroom, hair salon and other sites may require many types of syrups, drinks, cleaning liquids, including sanitizers, hair conditioners, dish washing soaps and hand soaps. While each liquid might be necessary, it can be cumbersome and unattractive to have each individual liquid receptacle placed on a countertop.

### BRIEF SUMMARY OF THE INVENTION

A Multiple Liquid Dispenser of the invention is a single appliance made to dispense at least one or a plurality of liquids. The device is equipped with at least one or a plurality of liquid tanks for each type of liquid. It is situated on a wide base for stability to prevent the dispenser from falling over as regular bottled soap dispensers are prone to doing. The dispenser has the option of having a power supply and a liquid temperature controller. The user can choose the liquid that will be dispensed by using a switch. The dispenser has an elongated spout so the user does not need to reach out as far to catch the liquid being dispensed.

### BRIEF DESCRIPTION OF THE SEVERAL VIEWS OF THE INVENTION

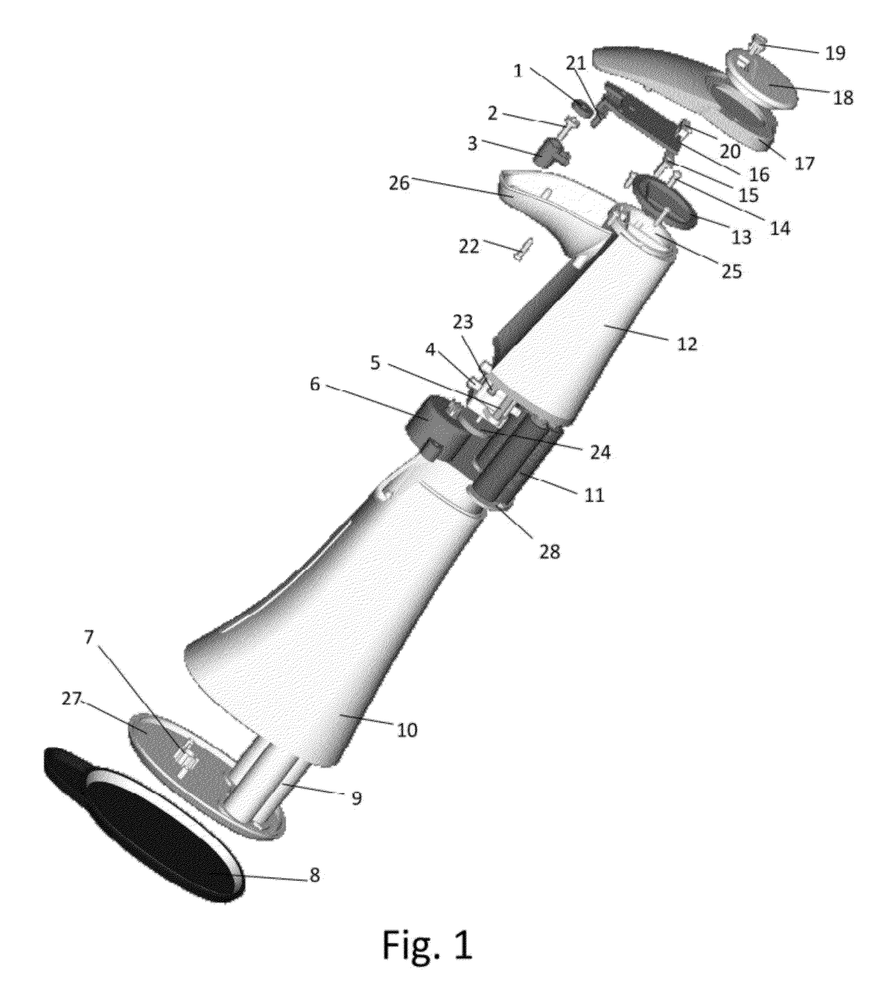

FIG. 1 is an exploded view of a Multiple Liquid Dispenser of the invention.

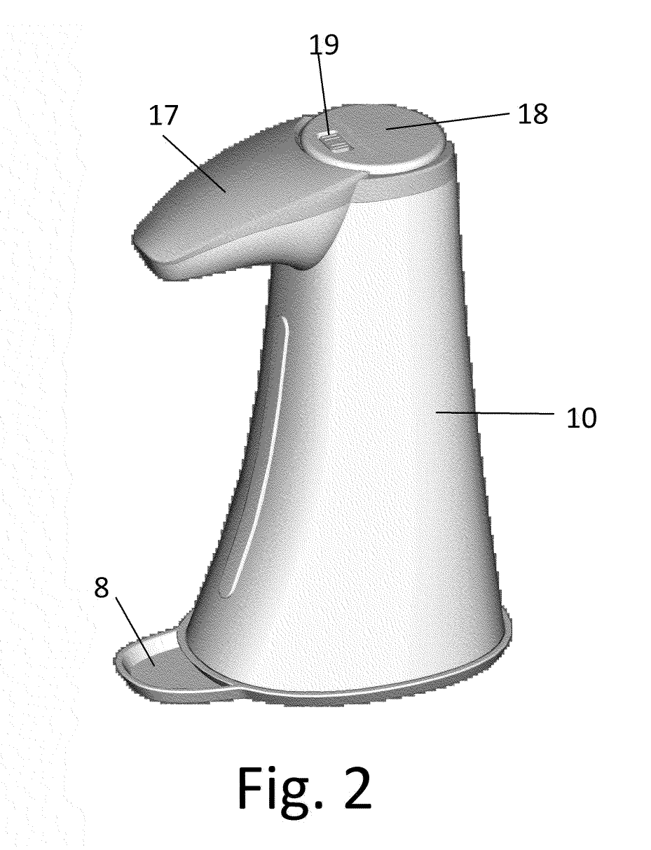

FIG. 2 is a side view of a Liquid Dispenser of the invention.

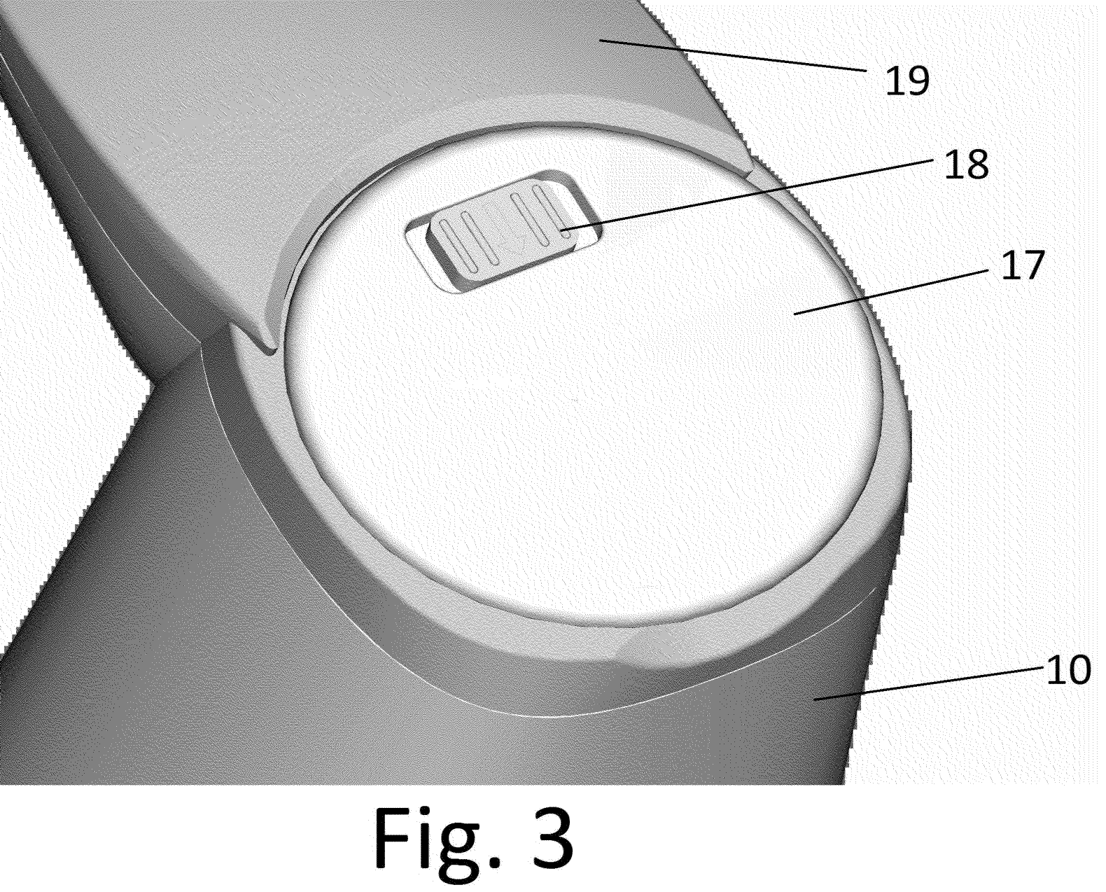

FIG. 3 is a magnified view of a top of a Multiple Liquid Dispenser of the invention.

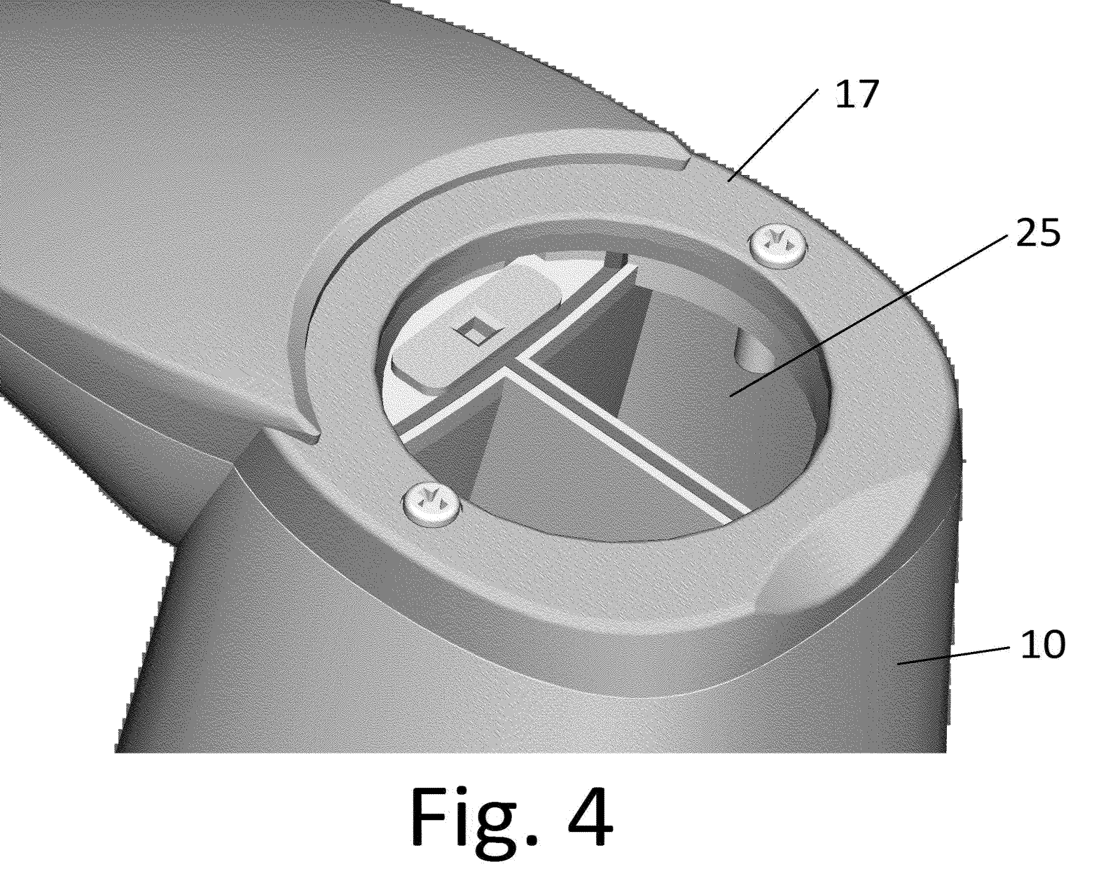

FIG. 4 is a view of internal tanks of a Multiple Liquid Dispenser of the invention.

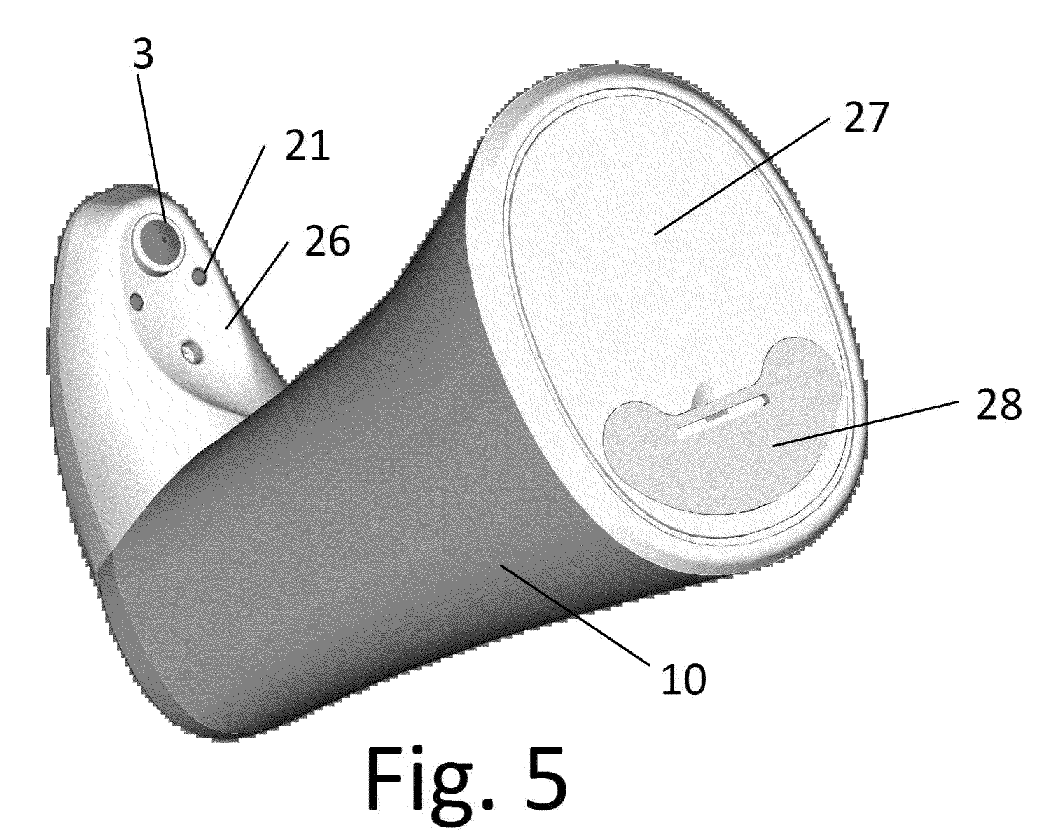

FIG. 5 is bottom side view of a Multiple Liquid Dispenser of the invention.

### DETAILED DESCRIPTION OF THE INVENTION

A Multiple Liquid Dispenser of the invention minimizes the amount separate liquid dispensers needed in a kitchen, bathroom, hair salon or other locations by combining multiple liquid tanks into one dispenser. The dispenser might not be placed in a spacious area, so it must firmly grip the surface that it will be placed on, to prevent the dispenser from shifting and falling. An elastic rubber material 8 can be placed under the base 27 of the dispenser for this purpose as seen in FIG. 1. An elastic rubber material 8 can also be used as a means of capturing any extraneous drops of liquid that have been dispensed, as it extends from the base 27 to the liquid dispensing outlet 3. The base 27 can have a built in battery slot 9 for an internal power supply and a motor resting position 7 to secure a pump motor 6. A power supply slot 9 houses a power supply 11, which can be covered by a cover 28. A pump motor 6, circuit board 16, temperature control unit 5, and light sensor 21 can all be powered by a power supply 11.

At least one liquid tank 25 or a plurality may be located in a tank housing section 12, which can be placed inside a dispenser housing section 10 for a more aesthetic appearance. A liquid tank 25 can be from metallic or non metallic material. The top of a tank housing section 12 can have a structural support piece 15 and structural support ring 13, which can be held down by at least one screw 14.

A pump motor 6 can be connected to a gear 24 that drives a pump 4. A temperature control unit 5 can keep liquids at a standard temperature of either a hot or cold beverage. A pump 4 can use an upper liquid inlet 23 to transport liquid from the liquid tank 25 to the liquid dispensing outlet 3. The liquid dispensing outlet 3 has at least one or a plurality of inlets for at least one or a plurality of liquids. The liquid dispensing outlet 3 can be sealed by a pin 2 and cover 1. The liquid dispensing outlet 3 is supported by an elongated spout support 26 and covered by an elongated spout cover 17. The elongated spout support 26 and elongated spout cover 17 can be held together by a spout screw 22. The elongated spout cover 17 can have a decorative circle 18, where a switch cover 19 can be placed. A switch cover 19 is attached to and controls the switch 20, which sets the type of liquid the user will dispense. A switch 20 can be connected to the circuit board 16, which can also be connected to a sensor 21. If a sensor is activated the specified liquid will begin to dispense through the liquid dispensing outlet 3. A switch 20 can also have the capability of dispensing liquid and setting the temperature control unit.

What is claimed is:

1. A liquid dispenser comprising:
one encompassing container; at least one or a plurality of tanks capable of dispensing at least one or a plurality of liquids; a switch capable of controlling from which tank or tanks liquid is being dispensed; a power supply; and a singular elongated spout for at least one or a plurality of liquids to dispense from.

2. A liquid dispenser as in claim 1 further comprising a motion sensor to activate liquid dispensing.

3. A liquid dispenser as in claim 1 further comprising a temperature control unit capable of regulating the temperature of each liquid tank.
